(19) United States
(12) Patent Application Publication
(10) Pub. No.: US 2022/0411640 A1
(43) Pub. Date: Dec. 29, 2022

(54) MULTICOLORED TURF IN-FILL AND METHOD OF MAKING

(71) Applicant: WESTERN STATES WHOLESALE, INC., Ontario, CA (US)

(72) Inventors: Michael Humphreys, Ontario, CA (US); Dong Hinh, Ontario, CA (US)

(21) Appl. No.: 17/849,498

(22) Filed: Jun. 24, 2022

Related U.S. Application Data
(60) Provisional application No. 63/215,376, filed on Jun. 25, 2021.

(51) Int. Cl. C09C 3/10; C09C 1/30; E01C 13/08

(52) U.S. Cl. CPC C09C 3/10; C09C 1/3072; E01C 13/08; C01P 2006/60

(57) ABSTRACT

Disclosed herein is a turf filler comprising a plurality of inorganic particles having a size of less than or equal to about 10 mesh at least partially encapsulated within a coating composition comprising a copolymer comprising one or more C₂-C₂₀ olefinic monomers and monomers of an ethylenically unsaturated ester of a C₂-C₁₀ carboxylic acid, wherein at least a first portion of the plurality of the particles further comprises a colorant, and a second portion of the plurality of particles is essentially free of a colorant. A method of producing the turf filler is also disclosed.

### CROSS REFERENCE TO RELATED APPLICATION

The present application claims priority to U.S. Provisional Pat. App. 63/215,376, filed Jun. 25, 2021; the entire disclosure of which is hereby incorporated herein by reference.

### FIELD OF THE DISCLOSURE

The present disclosure is directed to a filler for use with artificial turf, also referred to as infill, suitable for use on athletic playing fields, landscaped public, private areas, and the like. Methods of making the filler are also disclosed.

### BACKGROUND

Artificial surfaces are common for various reasons including aesthetic appearance, lower maintenance, evenness of the surface, and the like. Fillers for use with such surfaces are also common. Normally such fillers would include sand, crumb rubber and crushed stone. It is also known to color these fillers to enhance the appearance of the surface. However, fillers must not produce harmful dust, damage the artificial fibers, agglomerate or mound, become packed down or solidify, and should be sufficiently hydrophobic to allow drainage of the surface.

Turf fillers known in the art are typically monochromatic. Such turf fillers do not present the colors or the appearance of natural turf. There is need in the art to produce an acceptable turf filler or infill that presents an appearance more consistent with natural turf.

### SUMMARY

In embodiments, a turf filler comprises a plurality of inorganic particles having a size of less than or equal to about 10 mesh at least partially encapsulated within a coating composition comprising a colorant and a copolymer comprising:
i) one or more C₂-C₂₀ olefinic monomers and monomers of an ethylenically unsaturated ester of a C₂-C₁₀ carboxylic acid;
ii) a carboxylated styrene-butadiene copolymer; or
iii) a combination thereof,
   wherein the coating composition is essentially free of acrylic acid and polyacrylate polymers.

In embodiments, a process to produce the turf filler comprises the steps of:

contacting a plurality of inorganic particles having a size of less than or equal to about 10 mesh with an aqueous emulsion of the coating composition to at least partially encapsulate the plurality of inorganic particles within the coating composition; and

removing the solvent to produce a plurality of free flowing inorganic particles at least partially encapsulated within the coating composition;

wherein the coating composition comprises a colorant and a copolymer comprising:
i) one or more C₂-C₂₀ olefinic monomers and monomers of an ethylenically unsaturated ester of a C₂-C₁₀ carboxylic acid;
ii) a carboxylated styrene-butadiene copolymer; or
iii) a combination thereof; and

wherein the coating composition is essentially free of acrylic acid and polyacrylate polymers.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context.

Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

For use herein, the expressions “have”, “may have”, “include”, “comprise”, “may include”, and “may comprise” indicate the existence of corresponding features (e.g., such as numeric values, functions, operations, or components) but do not exclude the presence of additional features.

In the present disclosure, expressions such as, “A and/or B”, “at least one of A and/or B”, and “one or more of A and/or B”, may include any and all combinations of one or more of the associated listed items. For example, the terms “A and/or B” refers to the case (1) where A is included, (2) where B is included, or (3) where both A and B are included.

Terms such as “first”, “second”, and the like used herein may refer to various elements of various embodiments of the present disclosure, but do not limit the elements. For example, such terms are used only to distinguish an element from another element and do not limit the order and/or priority of the elements. For example, a first portion and a second portion represent different portions of a plurality of the items irrespective of sequence or importance. For example, without departing from the scope of the present disclosure, a first portion or element may be referred to as a second element, and similarly, a second portion or element may be referred to as a first portion or element.

The methods disclosed herein comprise one or more steps or actions for achieving the described method. Unless otherwise stated, the method steps and/or actions may be interchanged with one another without departing from the scope of the claims. In other words, unless a specific order of steps or actions is specified, the order and/or use of specific steps and/or actions may be modified without departing from the scope of the claims.

Within the present disclosure, the word “exemplary” and/or “preferably” are used to mean “serving as an example, instance, or illustration.” Any implementation or aspect described herein as “exemplary” and/or “preferably” is not necessarily to be construed as preferred or advantageous over other aspects of the disclosure in an overall limiting sense, but only in relation to specific embodiments. Likewise, the term “aspects” does not require that all aspects of the disclosure include the discussed feature, advantage or mode of operation.

The following detailed description is of the best currently contemplated modes of carrying out the invention. The description is not to be taken in a limiting sense, but is made merely for the purpose of illustrating the general principles of the invention.

For purposes herein, colors are indicated by the RGB color model, which is an additive color model that predicts the appearance of colors made by coincident component lights against an all-black background. Since RGB is a device-dependent color model meaning different devices detect or reproduce a given RGB value differently, since the color elements such as phosphors or dyes and their response to the individual R, G, and B levels vary from manufacturer to manufacturer, or even in the same device over time. Thus for consistency, the RGB values disclosed herein are subject to a color management scheme consistent with ISO 15076-1:2010 or an equivalent thereof. For purposes herein, the color is characterized by an RGB additive color model in which red, green, and blue are combined to produce the color expressed as the general formula (R, G, B), wherein R is a percentage of red from 0 to 100, G is a percentage of green from 0 to 100, and B is a percentage of blue from 0 to 100, wherein (0, 0, 0) represents black and (100, 100, 100) represents white when optically determined using a calibration according to ISO 15076 -1:2010, or an equivalent thereof. Furthermore, colors may be further characterized by trivial names assigned thereto.

For example, the color represented by (R, G, B) of (72.2, 61.2, 49.4), corresponds to RGB Decimal (184, 156, 126), wherein each of the integers are from 1 to 255. This color is further represented by hexadecimal triplet b89c7e, and is commonly referred to as being “slightly desaturated orange.” Other designations of this same color include:
CMYK 0, 15, 32, 28;
HSL 31°, 29, 60.8;
HSV (or HSB) 31°, 31.5, 72.2;
Web Safe cc9966;
CIE-LAB 66.117, 5.864, 19.573;
XYZ 35.421, 35.475, 24.719;
xyY 0.37, 0.371, 35.475;
CIE-LCH 66.117, 20.432, 73.322;
CIE-LUV 66.117, 19.732, 25.103;
Hunter-Lab 59.561, 1.925, 17.086; and/or
Binary 10111000, 10011100, 01111110.

For purposes herein, the RGB color is specified as (% R, % G, % B), while it is understood that the color or range of colors may be represented by other formulas and/or metrics which may be converted into the RGB percentage value. In other words, for purposes herein and the claims appended hereto, the RGB color based on percentages is specified, while it is understood that the color or range of colors may be represented by other formulas and/or metrics or formulae, which for purposes of determining the bounds of the following disclosure may be converted into the RGB percentage values.

In embodiments, a turf filler or turf infill comprises a plurality of inorganic particles having a size of less than or equal to about 10 mesh at least partially encapsulated within a coating composition comprising a copolymer comprising one or more C₂-C₂₀ olefinic monomers and monomers of an ethylenically unsaturated ester of a C₂-C₁₀ carboxylic acid, wherein at least a first portion of the plurality of the particles further comprises a colorant, and a second portion of the plurality of particles is essentially free of a colorant, i.e., less than about 0.0001 wt % of the colorant.

In embodiments, the coating composition is essentially free from acrylic acid, and polyacrylate polymers, i.e., less than about 0.01 wt % acrylic, if any and/or no acrylic or acrylate is intentionally added to the coating composition. For purposes herein, a polyacrylate polymer is a continuation of acrylic monomers comprising at least three acrylic moieties in succession. In some embodiments, the coating composition is a copolymer comprising a vinyl carboxylate comprising from 4 to 6 carbon atoms, and an alpha-olefin comprising from 2 to 8 carbon atoms. In some embodiments, the coating composition comprises vinyl acetate, vinyl propionate, vinyl butyrate, or a combination thereof copolymerized with ethylene, propylene, butene, hexene, octene, or a combination thereof.

In an embodiment, the coating composition comprises a vinyl acetate-ethylene copolymer (VAE). In embodiments, the coating composition is derived from an aqueous emulsion comprising the vinyl acetate-ethylene copolymer. In some embodiments, the VAE emulsion is an aqueous emulsion having a density of about 1.04 to 1.06 g/cm³ at 25° C., has a Brookfield viscosity from about 300 cps to 800 cps when determined according to AM622 using LVF #3 @ 60 rpm, 25° C., a glass transition temperature of less than or equal to about 5° C. when determined using DSC, or a combination thereof.

In embodiments, the coating composition present on the particles is transparent, translucent, or a combination thereof.

In embodiments, of the turf filler, each of the plurality of inorganic particles comprises (has) a color characterized by an RGB additive color model in which red, green, and blue are combined to produce the color expressed as the general formula (R, G, B), wherein R is a percentage of red from 0 to 100, G is a percentage of green from 0 to 100, and B is a percentage of blue from 0 to 100, wherein (0, 0, 0) represents black and (100, 100, 100) represents white when optically determined using a calibration according to ISO 15076-1:2010, or an equivalent thereof, wherein the first portion of the plurality of the particles comprises an amount of particles characterized as having a black color comprising an (R, G, B) color wherein the red is present at less than 1%, green is present at less than 1%, and blue is present at less than 1%; wherein the first portion of the plurality of the particles further comprises an amount of particles characterized as having a light gray color comprising an (R, G, B) color wherein the red is present from about 81% to 90%, green is present from about 81% to 90% and blue is present from about 81% to 90%; and wherein the first portion of the plurality of the particles further comprises an amount of particles characterized as having a very dark grayish green color comprising an (R, G, B) color wherein the red is present from about 28% to 37%, green is present from about 32% to 41% and blue is present from about 25% to 34%.

In some embodiments, the first portion of the plurality of the particles further comprises an amount of particles characterized as having a dark grayish green color comprising an (R, G, B) color wherein the red is present from about 58% to 67%, green is present from about 63% to 72%, and blue is present from about 54% to 63%, when optically determined using a calibration according to ISO 15076-1:2010, or an equivalent thereof.

In one or more embodiments, the first portion of the plurality of the particles further comprises an amount of particles characterized as having a very dark black-green color comprising an (R, G, B) color wherein the red is present from about 18% to 27%, green is present from about 1% to 10% and blue is present from about 1% to 10%, when optically determined using a calibration according to ISO 15076-1:2010, or an equivalent thereof.

In one or more embodiments, the first portion of the plurality of the particles further comprises an amount of particles characterized as having a very light gray color comprising an (R, G, B) color wherein the red is present from about 5% to 14%, green is present from about 6% to 15% and blue is present from about 4% to 13%, when optically determined using a calibration according to ISO 15076-1:2010, or an equivalent thereof.

In one or more embodiments, the first portion of the plurality of the particles further comprises an amount of particles characterized as having a dark grayish red color comprising an (R, G, B) color wherein the red is present from about 34% to 43%, green is present from about 24% to 33% and blue is present from about 24% to 33%, when optically determined using a calibration according to ISO 15076-1:2010, or an equivalent thereof.

In one or more embodiments, the first portion of the plurality of the particles further comprises an amount of particles characterized as having a very dark black-orange-brown color characterized by an (R, G, B) wherein the red is present from about 1% to 10%, green is present from about 1% to 10% and blue is present at less than 1, when optically determined using a calibration according to ISO 15076-1:2010, or an equivalent thereof.

In one or more embodiments the first portion of the plurality of the particles further comprises an amount of particles characterized as having a very dark yellow olive color comprising an (R, G, B) color wherein the red is present from about 28% to 37%, green is present from about 22% to 31% and blue is present from about 5% to 14%, when optically determined using a calibration according to ISO 15076-1:2010, or an equivalent thereof.

In one or more embodiments, the second portion of the plurality of the particles of the turf filler comprises an amount of particles characterized as having a mostly desaturated dark orange color comprising a RGB color wherein the red is present from about 51% to 64%, green is present from about 41% to 51%, and blue is present from about 27% to 38%, when optically determined using a calibration according to ISO 15076-1:2010, or an equivalent thereof.

In one or more embodiments, the second portion of the plurality of the particles comprises an amount of particles characterized as having a very dark desaturated orange color comprising an (R, G, B) color wherein the red is present from about 35% to 45%, green is present from about 26% to 36%, and blue is present from about 18% to 27%, when optically determined using a calibration according to ISO 15076-1:2010, or an equivalent thereof.

In one or more embodiments, the second portion of the plurality of the particles comprises an amount of particles characterized as having a slightly desaturated orange color comprising an (R, G, B) color wherein the red is present from about 67% to 75%, green is present from about 56% to 66%, and blue is present from about 45% to 54%, when optically determined using a calibration according to ISO 15076-1:2010, or an equivalent thereof.

In one or more embodiments, the plurality of inorganic particles comprise quartz and one or more of feldspar, mica, amphibole, pyroxene, and olivine. In some embodiments, the plurality of inorganic particles comprise greater than or equal to about 2 weight percent of calcium, sodium, and potassium combined, based on the total amount of the inorganic particles present.

In embodiments, the plurality of inorganic particles comprises naturally occurring sand, crushed rock, or a combination thereof. In some embodiments, the inorganic particles comprise or consist essentially of sand, preferably naturally occurring sand, preferably naturally occurring sand produced from the Bidahochi Formation, and/or Holocene River Alluvium.

In other embodiments, the plurality of inorganic particles comprises sand comprising greater than or equal to about 95 wt % silica, preferably greater than or equal to about 98 wt % silica or higher, which is preferably a naturally occurring sand and is not produced from crushed rock such that is has an average roundness index from about 0.35 to 1.00.

In embodiments, the colorant comprises a pigment, a dye, or a combination thereof having a green color, a yellow color, or a combination thereof. In embodiments, the turf filler further comprises an algae inhibitor, an anti-microbiological agent, a biocide, a fungicide, or combinations thereof. In embodiments, the plurality of inorganic particles have a Mohs hardness of greater than or equal to about 6.

In one or more embodiments, a process to produce the turf filler according to any one or more of the embodiments disclosed herein comprises the steps of contacting a plurality of inorganic particles having a size of less than or equal to about 10 mesh with a coating composition comprising an aqueous emulsion comprising one or more C₂-C₂₀ olefinic monomers and monomers of an ethylenically unsaturated ester of a C₂-C₁₀ carboxylic acid to at least partially encapsulate the plurality of inorganic particles within the coating composition; wherein a first portion of the coating composition further comprises a colorant, and wherein a second portion of the coating composition is essentially free from the colorant; removing the solvent at a temperature of less than about 50° C. to produce a plurality of free flowing inorganic particles at least partially encapsulated within the coating composition. In embodiments, the plurality of inorganic particles are coated in a mixer, a blender, a fluid bed, or a combination thereof.

In embodiments, the inorganic particulates are sand, preferably naturally occurring sand. In embodiments, the sand has a mesh size of less than about 10 (2 mm), or less than about mesh 12 (1.7 mm) or less than about mesh 14 (1.40 mm) and greater than (retained) about mesh 100 (0.150 mm), or greater than about mesh 80 (0.180 mm), or greater than about mesh 60 (0.250 mm), or greater than about mesh 45 (0.355 mm), or greater than mesh 40 (0.425 mm), and includes essentially no particulates less than mesh 200 (0.075 mm).

In embodiments, the turf fill comprises from about 0.05 wt % to about 0.5 wt % of the coating composition. In embodiments greater than or equal to about 0.1 wt %, or greater than or equal to about 0.2 wt %, or greater than or equal to about 0.3 wt % to less than or equal to about 0.5 wt % or less than or equal to about 0.45 wt % of the coating composition, based on the total amount of the turf fill present.

In embodiments, the inorganic particles have a roundness or sphericity from about 0.5 to 1, with from about 0.7 to about 0.9 being preferred.

In embodiments, the coating composition comprises or consists essentially of a fine particle size, aqueous dispersion of a vinyl acetate-ethylene (VAE) copolymer. In embodiments, the coating composition, as it exists prior to application to the particulates, comprises a solids content from about 54 wt % to 56.0%, a Brookfield viscosity from about 300-800 cPs (LVF #3 @60 rpm, 25° C.) determined according to AM622; a pH from about 5.0 to 6.0 determined according to AM631, a vinyl acetate monomer head space of <0.5% max when determined by GC-AM624; a density of about 1.04 to 1.08 g/cm³, and an average particle size from about 150 to 190 μm. In embodiments, the coating composition has a glass transition temperature of less than or equal to about 10° C., with less than or equal to about 5° C. and greater than or equal to about 0° C. being more preferred.

In embodiments, a portion of the particulates comprise a colorant. In embodiments, this is a green colorant, which in some embodiments is a mixture of a green and a yellow colorant. In embodiments, the colorant is a pigment, in the form of an emulsion or dispersion in a solvent, preferably an aqueous solvent. In other embodiments the colorant is a dye (a solution). In embodiments, The turf fill further comprises an antimicrobial component comprising zinc, which in embodiments is pyrithion zinc effective to at least partially inhibit mold growth and bacterial growth.

In embodiments, the turf fill has a low loss or matte finish, which is less than or equal to about 20 gloss units, or less than or equal to about 15 gloss units, or less than or equal to about 10 gloss units when determined at 60° according to ASTM D523 or an equivalent thereof.

In embodiments, the turf filler, comprises: a plurality of inorganic particles having a size of less than or equal to about 10 mesh at least partially encapsulated within a coating composition comprising a copolymer comprising one or more C₂-C₂₀ olefinic monomers and monomers of an ethylenically unsaturated ester of a C₂-C₁₀ carboxylic acid, wherein at least a first portion of the plurality of the particles further comprises a colorant.

In embodiments, the turf filler, comprises a plurality of inorganic particles having a size of less than or equal to about 10 mesh at least partially encapsulated within a coating composition comprising a carboxylated styrene-butadiene copolymer, wherein at least a first portion of the plurality of the particles further comprises a colorant. In embodiments, the turf filler comprises a second portion of the plurality of particles that is essentially free of a colorant.

In embodiments, the coating composition is essentially free from any free acrylic and/or free acrylate monomers.

In embodiments, the coating composition comprises a copolymer comprising carboxylated styrene-butadiene, which in embodiments is carboxylated with one of more of itaconic acid, fumaric acid, acrylic acid, or a combination thereof, subject to the proviso that the coating composition is essentially free from acrylic acid and/or any type of acrylate. In other embodiments, the coating composition comprises a copolymer comprising carboxylated styrene-butadiene, which is carboxylated with one of more of itaconic acid and fumaric acid.

In embodiments, the coating composition consists essentially of a carboxylated styrene-butadiene copolymer. In embodiments, the coating composition is derived from an aqueous emulsion comprising the carboxylated styrene-butadiene copolymer. In embodiments, the coating composition is derived from an aqueous latex emulsion.

In embodiments the filler plurality of inorganic particles comprising a colorant and/or which is essentially free of the colorant, further comprises a color characterized by an RGB additive color model in which red, green, and blue are combined to produce the color expressed as the general formula (R, G, B), wherein R is a percentage of red from 0 to 100, G is a percentage of green from 0 to 100, and B is a percentage of blue from 0 to 100, wherein (0, 0, 0) represents black and (100, 100, 100) represents white when optically determined using a calibration according to ISO 15076-1:2010, or an equivalent thereof, wherein at least a first portion of the plurality of the particles comprises an amount of particles characterized as having a black color comprising an (R, G, B) color wherein the red is present at less than 1%, green is present at less than 1%, and blue is present at less than 1%.

In embodiments, each of the plurality of inorganic particles comprising a colorant further comprises a color characterized by an RGB additive color model in which red, green, and blue are combined to produce the color expressed as the general formula (R, G, B), wherein R is a percentage of red from 0 to 100, G is a percentage of green from 0 to 100, and B is a percentage of blue from 0 to 100, wherein (0, 0, 0) represents black and (100, 100, 100) represents white when optically determined using a calibration according to ISO 15076-1:2010, or an equivalent thereof, wherein at least a first portion of the plurality of the particles comprises an amount of particles characterized as having a green color comprising an (R, G, B) color wherein the red is present from about 40% to 60%, green is present from about 50% to 100% and blue is present from about 0% to 30%.

In embodiments, a portion of the plurality of the particles comprises an amount of particles characterized as having a light gray color comprising an (R, G, B) color wherein the red is present from about 81% to 90%, green is present from about 81% to 90% and blue is present from about 81% to 90%, when optically determined using a calibration according to ISO 15076-1:2010, or an equivalent thereof.

In embodiments, a portion of the plurality of the particles comprises an amount of particles characterized as having a very dark grayish green color comprising an (R, G, B) color wherein the red is present from about 23% to 42%, green is present from about 27% to 46% and blue is present from about 20% to 39%, when optically determined using a calibration according to ISO 15076-1:2010, or an equivalent thereof.

In embodiments, a portion of the plurality of the particles comprises an amount of particles characterized as having a dark grayish green color comprising an (R, G, B) color wherein the red is present from about 53% to 72%, green is present from about 58% to 75%, and blue is present from about 49% to 68%, when optically determined using a calibration according to ISO 15076-1:2010, or an equivalent thereof.

In embodiments, a portion of the plurality of the particles comprises an amount of particles characterized as having a, wherein the first portion of the plurality of the particles further comprises an amount of particles characterized as having a very dark black-green color comprising an (R, G, B) color wherein the red is present from about 13% to 32%, green is present from about 1% to 10% and blue is present from about 1% to 10%, when optically determined using a calibration according to ISO 15076-1:2010, or an equivalent thereof.

In embodiments, a portion of the plurality of the particles comprises an amount of particles characterized as having a, wherein the first portion of the plurality of the particles further comprises an amount of particles characterized as having a very light gray color comprising an (R, G, B) color wherein the red is present from about 5% to 14%, green is present from about 6% to 15% and blue is present from about 4% to 13%, when optically determined using a calibration according to ISO 15076-1:2010, or an equivalent thereof.

In embodiments, a portion of the plurality of the particles further comprises an amount of particles characterized as having a dark grayish red color comprising an (R, G, B) color wherein the red is present from about 29% to 48%, green is present from about 19% to 38% and blue is present from about 19% to 38%, when optically determined using a calibration according to ISO 15076-1:2010, or an equivalent thereof.

In embodiments, a portion of the plurality of the particles further comprises an amount of particles characterized as having a very dark black-orange-brown color characterized by an (R, G, B) wherein the red is present from about 1% to 10%, green is present from about 1% to 10% and blue is present at less than 1, when optically determined using a calibration according to ISO 15076-1:2010, or an equivalent thereof.

In embodiments, a portion of the plurality of the particles further comprises an amount of particles characterized as having a very dark yellow olive color comprising an (R, G, B) color wherein the red is present from about 23% to 42%, green is present from about 17% to 361% and blue is present from about 5% to 19 when optically determined using a calibration according to ISO 15076-1:2010, or an equivalent thereof.

In embodiments, a portion of the plurality of the particles comprises an amount of particles characterized as having a mostly desaturated dark orange color comprising a RGB color wherein the red is present from about 46% to 69%, green is present from about 361% to 56%, and blue is present from about 22% to 43%, when optically determined using a calibration according to ISO 15076-1:2010, or an equivalent thereof.

In embodiments, a portion of the plurality of the particles comprises an amount of particles characterized as having a very dark desaturated orange color comprising an (R, G, B) color wherein the red is present from about 30% to 50%, green is present from about 21% to 41%, and blue is present from about 13% to 32%, when optically determined using a calibration according to ISO 15076-1:2010, or an equivalent thereof.

In embodiments, a portion of the plurality of the particles comprises an amount of particles characterized as having a slightly desaturated orange color comprising an (R, G, B) color wherein the red is present from about 62% to 80%, green is present from about 51% to 71%, and blue is present from about 40% to 59%, when optically determined using a calibration according to ISO 15076-1:2010, or an equivalent thereof.

### Process to Produce Turf Fill

In embodiments, a process to produce the turf filler according to any one or more embodiments disclosed herein includes the steps of contacting a plurality of inorganic particles having a size of less than or equal to about 10 mesh with the coating composition. In embodiments the coating composition applied to the particulates is an aqueous emulsion, preferably the coating composition applied to the particulates is an aqueous emulsion or dispersion comprising ethylene-vinyl acetate. In other embodiments, the coating composition applied to the particulates is an aqueous emulsion or dispersion comprising carboxylated styrene-butadiene latex.

In embodiments, the coating composition is first diluted in water and applied to the inorganic particulates at a temperature of less than or equal to about 70° C., preferably at a temperature of less than or equal to about 60° C., preferably at a temperature of less than or equal to about 50° C., with a temperature of less than or equal to about 40° C. being most preferred. This coating composition may include an antimicrobial agent or the antimicrobial agent may be applied separately. In embodiments, the coating composition is applied under mixing or shear e.g., in a ribbon blender. In other embodiments, the coating composition is applied in a fluid bed.

In embodiments, the coating composition is first diluted in water and applied to the inorganic particulates prior to the particles entering a fluid bed dryer and/or the coating composition is first diluted in water and applied to the inorganic particulates within a fluid bed dryer. The fluid bed may have variable temperature zones or may be isothermal. In embodiments, the coating composition is applied to the particles in a fluid bed at a temperature of less than or equal to about c preferably at a temperature of less than or equal to about 60° C., preferably at a temperature of less than or equal to about 50° C., with a temperature of less than or equal to about 40° C. being most preferred. The temperature of the fluid bed is then increased along a travel path from a beginning of the fluid bed to an end of the fluid bed, wherein the at least partially coated particles are dried in the fluid bed at a temperature of greater than or equal to about 50° C., or greater than or equal to about 60° C., or greater than or equal to about 70° C., or greater than or equal to about 80° C., or greater than or equal to about 90° C., or greater than or equal to about 100° C. for a period of time, i.e., a residence time, sufficient to remove the solvent and produce a free-flowing granular product. This coating composition may include an antimicrobial agent or the antimicrobial agent may be applied separately.

The method further includes removing the solvent, typically water, to produce a plurality of free flowing inorganic particles at least partially encapsulated within the coating composition.

In embodiments, the solvent is removed at a temperature of less than or equal to about 70° C., preferably at a temperature of less than or equal to about 60° C., preferably at a temperature of less than or equal to about 50° C., with a temperature of less than or equal to about 40° C. being most preferred. The solvent may be removed via vacuum belt drying, in a fluid bed, or by simple exposure to the atmosphere, preferably under agitation.

In embodiments, the coating composition comprises a colorant. The coating composition comprising the colorant is applied to the particles as an aerosol, e.g., pressure and/or air-assisted spraying of the particles in a fluid bed, the particles are heated in the fluid bed at a temperature and for a period of time sufficient to remove the solvent and produce a free-flowing particulate product comprising particles at least partially coated with the coating composition and having a plurality of colors due to the combination of the colorant present in a translucent or transparent layer of the coating, and the natural color of the particle that was coated. In some embodiments, the coated particulates is produced in a batch mode having a colorant and then the second portion of the coated particles is produced in a batch mode without the colorant. The first and second portions (batches) are then mixed to produce the final turf fill. In another embodiment, the first and the second portions are produced, dried and combined in a continuous process. In still other embodiments, the turf fill is produced in a continuous process in which the coating composition comprising the colorant is applied to all of the particles in the fluid bed in an amount sufficient to allow the natural color of the particle to combine with the colorant to produce the final color of the individual particle.

In embodiments, the colorant is present in the diluted coating composition at from about 1 to 10 parts colorant to 100 to 1000 parts coating composition. In embodiments, the coating composition comprising the colorant is applied to the particulates at a rate from about 1:100 (W:W, e.g. 1 pound of colorant to 100 pounds of particulate), to about 1:1000 W:W, or from about 1:200 to about 1:800, or from about 1:250 to about 1:550 W:W

In embodiments, a first portion of the coating composition comprises a colorant. In some embodiments, the first portion of the coated particulates is produced in a batch mode having a colorant and then the second portion of the coated particles is produced in a batch mode without the colorant. The first and second portions (batches) are then mixed to produce the final turf fill. In another embodiment, the first and the second portions are produced, dried and combined in a continuous process.

In embodiments, a process to produce the turf filler according to any one or more of the embodiments disclosed herein comprises the steps of contacting a plurality of inorganic particles having a size of less than or equal to about 10 mesh with an aqueous emulsion of the coating composition to at least partially encapsulate the plurality of inorganic particles within the coating composition; and removing the solvent to produce a plurality of free flowing inorganic particles at least partially encapsulated within the coating composition; wherein at least a first portion of the coating composition further comprises a colorant. In embodiments, the process further comprises contacting a second plurality of inorganic particles having a size of less than or equal to about 10 mesh with an aqueous emulsion of the coating composition to at least partially encapsulate the plurality of inorganic particles within the coating composition, wherein the coating composition is essentially free from the colorant.

In embodiments, a process to produce the turf filler according to one or more embodiments disclosed herein comprises contacting a plurality of inorganic particles having a size of less than or equal to about 10 mesh with a coating composition comprising an aqueous emulsion comprising one or more C₂-C₂₀ olefinic monomers and monomers of an ethylenically unsaturated ester of a C₂-C₁₀ carboxylic acid to at least partially encapsulate the plurality of inorganic particles within the coating composition; and removing the solvent at a temperature of less than about 50° C. to produce a plurality of free flowing inorganic particles at least partially encapsulated within the coating composition; wherein at least a first portion of the coating composition further comprises a colorant. In embodiments, a second portion of the plurality of inorganic particles are contacted with a second portion of the coating composition that is essentially free from a colorant.

In embodiments, the plurality of inorganic particles are coated in a mixer, a blender, a fluid bed, or a combination thereof.

In embodiments, the process further comprises combining a first amount of a first plurality of free flowing inorganic particles at least partially encapsulated within the coating composition comprising a colorant with a second amount of a second plurality of free flowing inorganic particles at least partially encapsulated within the coating composition essentially free of a colorant to produce the turf filler.

In some embodiments, the first plurality of free flowing inorganic particles at least partially encapsulated within the coating composition comprising a colorant are produced in a first batch, the second amount of a second plurality of free flowing inorganic particles at least partially encapsulated within the coating composition essentially free of a colorant are produced in a second batch, and at least to portion of the first batch and at least a portion of the second batch are combined to produce the turf filler.

In other embodiments of the process, the first plurality of free flowing inorganic particles at least partially encapsulated within the coating composition comprising a colorant are produced simultaneously with the second amount of a second plurality of free flowing inorganic particles at least partially encapsulated within the coating composition essentially free of a colorant, and at least a portion of each are combined in a continuous or semi-continuous process to produce the turf filler.

### Embodiments

Embodiments according to the instant disclosure include:
E1. A turf filler, comprising:
   a plurality of inorganic particles having a size of less than or equal to about 10 mesh at least partially encapsulated within a coating composition comprising a copolymer comprising one or more C2-C20 olefinic monomers and monomers of an ethylenically unsaturated ester of a C2-C10 carboxylic acid,
   wherein at least a first portion of the plurality of the particles further comprises a colorant.
E2. A turf filler, comprising:
a plurality of inorganic particles having a size of less than or equal to about 10 mesh at least partially encapsulated within a coating composition comprising a carboxylated styrene-butadiene copolymer, wherein at least a first portion of the plurality of the particles further comprises a colorant.
E3. A turf filler, comprising:
   a plurality of inorganic particles having a size of less than or equal to about 10 mesh at least partially encapsulated within a coating composition comprising a colorant and a copolymer comprising:
   i) one or more C₂-C₂₀ olefinic monomers and monomers of an ethylenically unsaturated ester of a C₂-C₁₀ carboxylic acid;
   ii) a carboxylated styrene-butadiene copolymer; or
   iii) a combination thereof,
   wherein the coating composition is essentially free of acrylic acid and polyacrylate polymers.
E4. The turf filler of any one of embodiments E1 through E3, wherein the coating composition is essentially free from acrylic and/or acrylate monomers.
E5. The turf filler of any one of embodiments E1 or E3 through E4, wherein the coating composition is a copolymer comprising a vinyl carboxylate comprising from 4 to 6 carbon atoms, and an alpha olefin comprising from 2 to 8 carbon atoms.
E6. The turf filler of any one of embodiments E1 or E3 through E5, wherein the coating composition comprises vinyl acetate, vinyl propionate, vinyl butyrate, or a combination thereof copolymerized with ethylene, propylene, butene, hexene, octene, or a combination thereof.
E7. The turf filler of any one of embodiments E1 or E3 through E6, wherein the coating composition comprises a vinyl acetate-ethylene copolymer.
E8. The turf filler of any one of embodiments E1 or E3 through E7, wherein the coating composition consists essentially of a vinyl acetate-ethylene copolymer.
E9. The turf filler of any one of embodiments E1 or E3 through E8, wherein the coating composition is derived from an aqueous emulsion comprising the vinyl acetate-ethylene copolymer.
E10. The turf filler of embodiment E9, wherein the aqueous emulsion has a density of about 1.04 to 1.06 g/cm3 at 25° C., has a Brookfield viscosity from about 300 cps to 800 cps when determined according to AM622 using LVF #3 @ 60 rpm, 25° C., a glass transition temperature of less than or equal to about 5° C. when determined using DSC, or a combination thereof.
E11. The turf filler of any one of embodiments E2 through E4, wherein the coating composition comprises a copolymer comprising styrene, butadiene, and one of more of itaconic acid, fumaric acid, or a combination thereof.
E12. The turf filler of any one of embodiments E2 through E4, or E11, wherein the coating composition consists essentially of a carboxylated styrene-butadiene copolymer.
E13. The turf filler of any one of embodiments E2 through E4, E11 or E12, wherein the coating composition is derived from an aqueous emulsion comprising the carboxylated styrene-butadiene copolymer.
E14. The turf filler of any one of embodiments E2 through E4 or E11 through E13, wherein the coating composition is derived from an aqueous latex emulsion.
E15. The turf filler of any one of embodiments E1 through E14, wherein the coating composition present on the particles is transparent, translucent, or a combination thereof.
E16. The turf filler of any one of embodiments E1 through E15, wherein each of the plurality of inorganic particles comprising a colorant further comprises a color characterized by an RGB additive color model in which red, green, and blue are combined to produce the color expressed as the general formula (R, G, B), wherein R is a percentage of red from 0 to 100, G is a percentage of green from 0 to 100, and B is a percentage of blue from 0 to 100, wherein (0, 0, 0) represents black and (100, 100, 100) represents white when optically determined using a calibration according to ISO 15076-1:2010, or an equivalent thereof,
   wherein at least a first portion of the plurality of the particles comprises an amount of particles characterized as having a black color comprising an (R, G, B) color wherein the red is present at less than 1%, green is present at less than 1%, and blue is present at less than 1%.
E17. The turf filler of any one of embodiments E1 through E16, wherein each of the plurality of inorganic particles comprising a colorant further comprises a color characterized by an RGB additive color model in which red, green, and blue are combined to produce the color expressed as the general formula (R, G, B), wherein R is a percentage of red from 0 to 100, G is a percentage of green from 0 to 100, and B is a percentage of blue from 0 to 100, wherein (0, 0, 0) represents black and (100, 100, 100) represents white when optically determined using a calibration according to ISO 15076-1:2010, or an equivalent thereof, wherein at least a first portion of the plurality of the particles comprises an amount of particles characterized as having a green color comprising an (R, G, B) color wherein the red is present from about 40% to 60%, green is present from about 50% to 100% and blue is present from about 0% to 30%.
E18. The turf filler of any one of embodiments E1 through E17, wherein another portion of the plurality of the particles comprises an amount of particles characterized as having a light gray color comprising an (R, G, B) color wherein the red is present from about 81% to 90%, green is present from about 81% to 90% and blue is present from about 81% to 90%, when optically determined using a calibration according to ISO 15076-1:2010, or an equivalent thereof.
E19. The turf filler of any one of embodiments E1 through E18, wherein another portion of the plurality of the particles comprises an amount of particles characterized as having a very dark grayish green color comprising an (R, G, B) color wherein the red is present from about 23% to 42%, green is present from about 27% to 46% and blue is present from about 20% to 39%, when optically determined using a calibration according to ISO 15076-1:2010, or an equivalent thereof.
E20. The turf filler of any one of embodiments E1 through E19, wherein another portion of the plurality of the particles comprises an amount of particles characterized as having a dark grayish green color comprising an (R, G, B) color wherein the red is present from about 53% to 72%, green is present from about 58% to 75%, and blue is present from about 49% to 68%, when optically determined using a calibration according to ISO 15076-1:2010, or an equivalent thereof.
E21. The turf filler of any one of embodiments E1 through E20, wherein another portion of the plurality of the particles comprises an amount of particles characterized as having a, wherein the first portion of the plurality of the particles further comprises an amount of particles characterized as having a very dark black-green color comprising an (R, G, B) color wherein the red is present from about 13% to 32%, green is present from about 1% to 10% and blue is present from about 1% to 10%, when optically determined using a calibration according to ISO 15076-1:2010, or an equivalent thereof.
E22. The turf filler of any one of embodiments E1 through E21, wherein another portion of the plurality of the particles comprises an amount of particles characterized as having a, wherein the first portion of the plurality of the particles further comprises an amount of particles characterized as having a very light gray color comprising an (R, G, B) color wherein the red is present from about 5% to 14%, green is present from about 6% to 15% and blue is present from about 4% to 13%, when optically determined using a calibration according to ISO 15076-1:2010, or an equivalent thereof.
E23. The turf filler of any one of embodiments E1 through E22, wherein another portion of the plurality of the particles further comprises an amount of particles characterized as having a dark grayish red color comprising an (R, G, B) color wherein the red is present from about 29% to 48%, green is present from about 19% to 38% and blue is present from about 19% to 38%, when optically determined using a calibration according to ISO 15076-1:2010, or an equivalent thereof.
E24. The turf filler of any one of embodiments E1 through E23, wherein another portion of the plurality of the particles further comprises an amount of particles characterized as having a very dark black-orange-brown color characterized by an (R, G, B) wherein the red is present from about 1% to 10%, green is present from about 1% to 10% and blue is present at less than 1, when optically determined using a calibration according to ISO 15076-1:2010, or an equivalent thereof.
E25. The turf filler of any one of embodiments E1 through E24, wherein another portion of the plurality of the particles further comprises an amount of particles characterized as having a very dark yellow olive color comprising an (R, G, B) color wherein the red is present from about 23% to 42%, green is present from about 17% to 361% and blue is present from about 5% to 19 when optically determined using a calibration according to ISO 15076-1:2010, or an equivalent thereof.
E26. The turf filler of any one of embodiments E1 through E25, wherein another portion of the plurality of the particles comprises an amount of particles characterized as having a mostly desaturated dark orange color comprising a RGB color wherein the red is present from about 46% to 69%, green is present from about 361% to 56%, and blue is present from about 22% to 43%, when optically determined using a calibration according to ISO 15076-1:2010, or an equivalent thereof.
E27. The turf filler of any one of embodiments E1 through E26 wherein another portion of the plurality of the particles comprises an amount of particles characterized as having a very dark desaturated orange color comprising an (R, G, B) color wherein the red is present from about 30% to 50%, green is present from about 21% to 41%, and blue is present from about 13% to 32%, when optically determined using a calibration according to ISO 15076-1:2010, or an equivalent thereof.
E28. The turf filler of any one of embodiments E1 through E27, wherein another portion of the plurality of the particles comprises an amount of particles characterized as having a slightly desaturated orange color comprising an (R, G, B) color wherein the red is present from about 62% to 80%, green is present from about 51% to 71%, and blue is present from about 40% to 59%, when optically determined using a calibration according to ISO 15076-1:2010, or an equivalent thereof.
E29. The turf filler of any one of embodiments E1 through E28, wherein the plurality of inorganic particles comprise quartz and one or more of feldspar, mica, amphibole, pyroxene, and olivine.
E30. The turf filler of any one of embodiments E1 through E29, wherein the plurality of inorganic particles comprise greater than or equal to about 2 weight percent of calcium, sodium, and potassium combined, based on the total amount of the inorganic particles present.
E31. The turf filler of any one of embodiments E1 through E30, wherein the plurality of inorganic particles comprises naturally occurring sand, crushed rock, or a combination thereof.
E32. The turf filler of any one of embodiments E1 through E31, wherein the plurality of inorganic particles comprises sand produced from the Bidahochi Formation, Holocene River Alluvium, or a combination thereof.
E33. The turf filler of any one of embodiments E1 through E32, wherein the plurality of inorganic particles comprises sand comprising greater than or equal to about 95 wt % silica.
E34. The turf filler of any one of embodiments E1 through E33, wherein the plurality of inorganic particles have an average roundness index from about 0.35 to 1.00.
E35. The turf filler of any one of embodiments E1 through E34, having a matt finish.
E36. The turf filler of any one of embodiments E1 through E35, having a low gloss or matte finish having less than or equal to about 20 gloss units when determined at 60° according to ASTM D523.
E37. The turf filler of any one of embodiments E1 through E36, wherein the colorant comprises a pigment, a dye, or a combination thereof having a green color, a yellow color, or a combination thereof.
E38. The turf filler of any one of embodiments E1 through E37, further comprising an algae inhibitor, an anti-microbiological agent, a biocide, a fungicide, or combinations thereof.
E39. The turf filler of any one of embodiments E1 through E38, wherein the plurality of inorganic particles have a Mohs hardness of greater than or equal to about 6.
E40. A process to produce the turf filler according to any one of embodiments E1 through E39, comprising:
   contacting a plurality of inorganic particles having a size of less than or equal to about 10 mesh with an aqueous emulsion of the coating composition to at least partially encapsulate the plurality of inorganic particles within the coating composition; and
   removing the solvent to produce a plurality of free flowing inorganic particles at least partially encapsulated within the coating composition;
   wherein at least a first portion of the coating composition further comprises a colorant.
E41. The process of embodiment E40, further comprising contacting a second plurality of inorganic particles having a size of less than or equal to about 10 mesh with an aqueous emulsion of the coating composition to at least partially encapsulate the plurality of inorganic particles within the coating composition, wherein the coating composition is essentially free from the colorant.
E42. A process to produce the turf filler according to any one of embodiments E1 through E9 or E14 through E39, comprising:
   contacting a plurality of inorganic particles having a size of less than or equal to about 10 mesh with a coating composition comprising an aqueous emulsion comprising one or more C2-C20 olefinic monomers and monomers of an ethylenically unsaturated ester of a C2-C10 carboxylic acid to at least partially encapsulate the plurality of inorganic particles within the coating composition; and
   removing the solvent at a temperature of less than about 50° C. to produce a plurality of free flowing inorganic particles at least partially encapsulated within the coating composition;
   wherein at least a first portion of the coating composition further comprises a colorant.
E43. The process of embodiment E42, wherein a second portion of the plurality of inorganic particles are contacted with a second portion of the coating composition that is essentially free from a colorant.
E44. The process of any one of embodiments E40 through E43, wherein the plurality of inorganic particles are coated in a mixer, a blender, a fluid bed, or a combination thereof.
E45. The process of any one of embodiments E40 through E44, further comprising combining a first amount of a first plurality of free flowing inorganic particles at least partially encapsulated within the coating composition comprising a colorant with a second amount of a second plurality of free flowing inorganic particles at least partially encapsulated within the coating composition essentially free of a colorant to produce the turf filler.
E46. The process of embodiment E45, wherein the first plurality of free flowing inorganic particles at least partially encapsulated within the coating composition comprising a colorant are produced in a first batch, the second amount of a second plurality of free flowing inorganic particles at least partially encapsulated within the coating composition essentially free of a colorant are produced in a second batch, and at least to portion of the first batch and at least a portion of the second batch are combined to produce the turf filler.
E47. The process of embodiment E45, wherein the first plurality of free flowing inorganic particles at least partially encapsulated within the coating composition comprising a colorant are produced simultaneously with the second amount of a second plurality of free flowing inorganic particles at least partially encapsulated within the coating composition essentially free of a colorant, and at least a portion of each are combined in a continuous or semi-continuous process to produce the turf filler.
E48. A process to produce the turf filler, comprising:
   contacting a plurality of inorganic particles having a size of less than or equal to about 10 mesh with an aqueous emulsion of the coating composition to at least partially encapsulate the plurality of inorganic particles within the coating composition; and
   removing the solvent to produce a plurality of free flowing inorganic particles at least partially encapsulated within the coating composition;
   wherein the coating composition comprises a colorant and a copolymer comprising:
   i) one or more C₂-C₂₀ olefinic monomers and monomers of an ethylenically unsaturated ester of a C₂-C₁₀ carboxylic acid;
   ii) a carboxylated styrene-butadiene copolymer; or
   iii) a combination thereof; and
   wherein the coating composition is essentially free of acrylic acid and polyacrylate polymers.
E49. The process of embodiment E48, wherein the plurality of inorganic particles are contacted with the coating composition in a continuous process within a fluid bed dryer.
E50. The process of embodiment E48 or E49, wherein a maximum temperature of the inorganic particles within the fluid bed dryer is less than or equal to about 90° C.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

A phrase referring to “at least one of:” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1.-47. (canceled)

48. A turf filler, comprising:
a plurality of inorganic particles having a size of less than or equal to about 10 mesh at least partially encapsulated within a coating composition comprising a colorant and a copolymer comprising:
i) one or more C₂-C₂₀ olefinic monomers and monomers of an ethylenically unsaturated ester of a C₂-C₁₀ carboxylic acid;
ii) a carboxylated styrene-butadiene copolymer; or
iii) a combination thereof,
wherein the coating composition is essentially free of acrylic acid and polyacrylate polymers.

49. The turf filler of claims 48, wherein the coating composition comprises a vinyl acetate-ethylene copolymer.

50. The turf filler of claim 48, wherein the coating composition consists essentially of a colorant and vinyl acetate-ethylene copolymer.

51. The turf filler of claim 48, wherein the coating composition comprises a colorant, and a carboxylated styrene-butadiene copolymer comprising styrene, butadiene, and one of more of itaconic acid and fumaric acid.

52. The turf filler of claim 48, wherein the coating composition consists essentially of a colorant and carboxylated styrene-butadiene copolymer.

53. The turf filler of claim 48, wherein the coating composition is derived from an aqueous emulsion comprising a colorant and:
i) one or more C₂-C₂₀ olefinic monomers and monomers of an ethylenically unsaturated ester of a C₂-C₁₀ carboxylic acid;
ii) a carboxylated styrene-butadiene copolymer; or
iii) a combination thereof.

54. The turf filler of claim 53, wherein the aqueous emulsion has a density of about 1.04 to 1.06 g/cm³ at 25° C., has a Brookfield viscosity from about 300 cps to 800 cps when determined according to AM622 using LVF #3 @ 60 rpm, 25° C., a glass transition temperature of less than or equal to about 5° C. when determined using DSC, or a combination thereof.

55. The turf filler of claim 48, wherein the coating composition present on the particles is transparent, translucent, or a combination thereof.

56. The turf filler of claim 48, wherein each of the plurality of inorganic particles further comprises a color characterized by an RGB additive color model in which red, green, and blue are combined to produce the color expressed as the general formula (R, G, B), wherein R is a percentage of red from 0 to 100, G is a percentage of green from 0 to 100, and B is a percentage of blue from 0 to 100, wherein (0, 0, 0) represents black and (100, 100, 100) represents white when optically determined using a calibration according to ISO 15076-1:2010, or an equivalent thereof;
wherein a first portion of the plurality of the particles is characterized as having a black color comprising an (R, G, B) color wherein the red is present at less than 1%, green is present at less than 1%, and blue is present at less than 1%, when optically determined using a calibration according to ISO 15076-1:2010, or an equivalent thereof; and
a second portion of the plurality of the particles is characterized as having a green color comprising an (R, G, B) color wherein the red is present from about 40% to 60%, green is present from about 50% to 100% and blue is present from about 0% to 30%, when optically determined using a calibration according to ISO 15076-1:2010, or an equivalent thereof.

57. The turf filler of claim 56, wherein a third portion of the plurality of the particles is characterized as having a light gray color comprising an (R, G, B) color wherein the red is present from about 81% to 90%, green is present from about 81% to 90% and blue is present from about 81% to 90%, when optically determined using a calibration according to ISO 15076-1:2010, or an equivalent thereof.

58. The turf filler of claim 57, wherein a fourth portion of the plurality of the particles is characterized as having a very dark grayish green color comprising an (R, G, B) color wherein the red is present from about 23% to 42%, green is present from about 27% to 46% and blue is present from about 20% to 39%, when optically determined using a calibration according to ISO 15076-1:2010, or an equivalent thereof.

59. The turf filler of claim 48, wherein the plurality of inorganic particles comprises naturally occurring sand, crushed rock, or a combination thereof.

60. The turf filler of claim 48, wherein the plurality of inorganic particles comprises sand produced from the Bidahochi Formation, Holocene River Alluvium, or a combination thereof.

61. The turf filler of claim 48, wherein the plurality of inorganic particles comprise:
i) an average roundness index from about 0.35 to 1.00.

62. The turf filler of claim 48, having a low gloss or matte finish having less than or equal to about 20 gloss units when determined at 60° according to ASTM D523.

63. The turf filler of claim 48, wherein the colorant comprises a pigment, a dye, or a combination thereof having a green color, a yellow color, or a combination thereof.

64. The turf filler of claim 48, further comprising an algae inhibitor, an anti-microbiological agent, a biocide, a fungicide, or combinations thereof.

65. A process to produce the turf filler, comprising:
contacting a plurality of inorganic particles having a size of less than or equal to about 10 mesh with an aqueous emulsion of the coating composition to at least partially encapsulate the plurality of inorganic particles within the coating composition; and
removing the solvent to produce a plurality of free flowing inorganic particles at least partially encapsulated within the coating composition;
wherein the coating composition comprises a colorant and a copolymer comprising:
i) one or more C₂-C₂₀ olefinic monomers and monomers of an ethylenically unsaturated ester of a C₂-C₁₀ carboxylic acid;
ii) a carboxylated styrene-butadiene copolymer; or
iii) a combination thereof; and
wherein the coating composition is essentially free of acrylic acid and polyacrylate polymers.

66. The process of claim 65, wherein the plurality of inorganic particles are contacted with the coating composition in a continuous process within a fluid bed dryer.

67. The process of claim 65, wherein a maximum temperature of the inorganic particles within the fluid bed dryer is less than or equal to about 90° C.
